(19) United States
(12) Patent Application Publication
(10) Pub. No.: US 2013/0113365 A1
(43) Pub. Date: May 9, 2013

(54) METHOD OF PRODUCING COATED PHOSPHOR, COATED PHOSPHOR AND WHITE LIGHT SOURCE

(71) Applicant: Sony Chemical & Information Device Corporation, Tokyo (JP)

(72) Inventors: Takehiro Yamasuge, Tokyo (JP); Masahide Daimon, Tokyo (JP); Tsuneo Kusunoki, Tokyo (JP)

(73) Assignee: SONY CHEMICAL & INFORMATION DEVICE CORPORATION, Tokyo (JP)

(21) Appl. No.: 13/624,424

(22) Filed: Sep. 21, 2012

(30) Foreign Application Priority Data
Sep. 21, 2011 (JP) 2011206377

(51) Int. Cl. C09K 11/77; H05B 33/14

(52) U.S. Cl. CPC C09K 11/7734; H05B 33/14
USPC 313/503; 252/301.4 F; 427/162

(57) ABSTRACT

To provide a coated phosphor having good phosphor characteristics that can maintain light emitting characteristic for a long period of time. A mixing process is prepared in which a phosphor and aluminum alkoxide are mixed in a solvent so that the phosphor is coated with an aluminum oxide formed from the aluminum alkoxide, and the phosphor contains Group II element (M), europium (Eu), silicon (Si) and oxygen (O) in atomic weight ratios represented by the following composition formula (1):

[(M)₁₋ₓEuₓ]ₐSi_{b}O_{c} Composition Formula (1)

In the composition formula (1), a, b, c and x satisfy relationships: 1.8<a<3.3; 0.9<b<1.1; 3.6<c <5.5; and 0<x<0.09.

### BACKGROUND OF THE INVENTION

1. Field of the Invention

The present invention relates to a method of producing a coated phosphor in which a phosphor is coated with a coating material, such a coated phosphor and a white light source.

2. Description of the Related Art

In an attempt to carry out a metal coating process on a phosphor having low moisture resistance, for example, Patent Literature 1 (JP-A No. 2007-23221) has proposed a technique (sol-gel method) which utilizes a hydrolysis reaction of metal alkoxide, with SiO₂ being used as a coating material. In an embodiment of Patent Literature 1 (JP-A No. 2007-23221), a phosphor is dispersed and mixed in a reaction solution as a suspension, and treated by a sol-gel reaction for 8 hours so that after washing processes have been repeated thereon so as to reduce conductivity in the solution caused by elution of impurities to 100 μS/cm or less, a drying process and a firing process are carried out thereon to provide a coated light emitting material.

Moreover, as a method for coating phosphor particles with various kinds of metal oxides, such a method has been described in Patent Literature 2 (JP-A No. 04-279693) or the like. More specifically, to 100 parts by weight of a phosphor (sulfide) as a subject, metal alkoxide is added at a rate of 0.2 mol/hour or less, while H₂O serving as an initiator is simultaneously added to 1 mol of the addition metal source at a rate of 0.01 to 5.0 mol, so that by carrying out a drying process and a firing process thereon, the coating material is adhered thereto.

In Patent Literature 2 (JP-A No. 04-279693), with respect to the phosphor serving as the subject, the coated phosphor is evaluated by examining properties thereof, such as UV degradation, burning, Cu contamination, conductivity, hydrophilicity, dispersing property and the like.

In the case of an oxide phosphor represented by ((Ba_{1-y}, Sr_{y})₁₋ₓEuₓ)ₐSi_{b}O_{c}, this phosphor has a light emission peak in a wavelength range of 600 to 610 nm and exerts good characteristics as a phosphor. However, the phosphor is fragile to moisture in its own property and has a problem in its long-term reliability, with the result that this has not been put into practical use. Therefore, to solve this problem, countermeasures against poor moisture resistance have been examined.

However, for example, for the application to backlights or LED's for illumination, which requires a long service life, the properties thereof cannot be said to be sufficient. More specifically, acceleration test environments for a white LED package (PKG) are in general 85° C. and 85% RH. For this reason, the phosphor itself, dispersed in the resin on a white LED package, needs to have performances that withstand these environments.

With respect to these required performances (required specifications), Patent Literature 2 (JP-A No. 04-279693), which uses a sulfide as a subject phosphor, gives no description about tests under a high-temperature high-moisture environment.

Moreover, upon carrying out a sol-gel method, since a hydrolysis reaction process of metal alkoxide is inevitably included, addition of H₂O into the system is not avoidable. For example, in the case when TEOS (tetraethoxysilane) having a slow reaction speed is used as a coating film source, an extremely large amount of H₂O is required. This causes one reason for accelerating degradation of the phosphor itself during a surface treating process.

Furthermore, Patent Literature 1 (JP-A No. 2007-23221) has described that the reliability can be improved by increasing the number of film coating processes; however, as described earlier, the film coating process in the case of using TEOS that is slow in reaction speed has a limitation in the growth of the film thickness on the surface of each particle, making it doubtful as to whether or not the required performances can be achieved.

The present invention has been devised in view of these circumstances, and its object is to provide a method of producing a coated phosphor that has superior phosphor characteristics, and can maintain its light emitting characteristic for a long period of time, such a coated phosphor and a white light source.

### SUMMARY OF THE INVENTION

A method of producing a coated phosphor in accordance with the present invention is provided with the step of: mixing a phosphor and aluminum alkoxide in a solvent so that the phosphor is coated with an aluminum oxide formed from the aluminum alkoxide, and the phosphor contains Group II element (M), europium (Eu), silicon (Si) and oxygen (O) in atomic weight ratios represented by the following composition formula (1):

[(M)₁₋ₓEuₓ]ₐSi_{b}O_{c} Composition Formula (1)

In the composition formula (1), a, b, c and x satisfy relationships: 1.8<a<3.3; 0.9<b<1.1; 3.6<c<5.5; and 0<x<0.09.

A coated phosphor in accordance with the present invention has a phosphor coated with an aluminum oxide, and the phosphor contains Group II element (M), europium (Eu), silicon (Si) and oxygen (O) in atomic weight ratios represented by the following composition formula (1):

[(M)₁₋ₓEuₓ]ₐSi_{b}O_{c} Composition Formula (1)

In the composition formula (1), a, b, c and x satisfy relationships: 1.8<a<3.3; 0.9<b<1.1; 3.6<c<5.5; and 0<x<0.09.

A white light source in accordance with the present invention is provided with: a blue light emitting diode formed on an element substrate; a knead matter that is placed on the blue light emitting diode, and formed by kneading a red phosphor and a green phosphor or a yellow phosphor with a transparent resin, and the red phosphor is a phosphor coated with an aluminum oxide, and the phosphor contains Group II element (M), europium (Eu), silicon (Si) and oxygen (O) in atomic weight ratios represented by the following composition formula (1):

[(M)₁₋ₓEuₓ]ₐSi_{b}O_{c} Composition Formula (1)

In the composition formula (1), a, b, c and x satisfy relationships: 1.8<a<3.3; 0.9<b<1.1; 3.6<c<5.5; and 0<x<0.09.

In accordance with the present invention, it is possible to obtain a coated phosphor that has superior phosphor characteristics, and can maintain its light emitting characteristic for a long period of time

### BRIEF DESCRIPTION OF THE DRAWINGS

FIG. 1 is a schematic cross-sectional view illustrating a white light source in accordance with one embodiment of the present invention.

FIG. 2A is a schematic plan view illustrating an illumination apparatus in accordance with one embodiment of the present invention.

FIG. 2B is a schematic plan view illustrating an illumination apparatus in accordance with one embodiment of the present invention.

FIG. 3 is a schematic cross-sectional view illustrating the illumination apparatus in accordance with the embodiment of the present invention.

FIG. 4 is a graph in which characteristics of a phosphor before and after a coating treatment are compared with each other.

FIG. 5 is a graph that shows a change in specific surface area due to a ratio of existence of Al/(Sr+Ba) element.

FIG. 6 is a drawing that shows electron microscopic photographs of evaluation samples obtained by examples 1 to 5 as well as comparative examples 3 and 4.

FIG. 7 is a graph that shows results of high-temperature/high-moisture environmental tests.

FIG. 8 is a graph that shows a change in reliability due to a reaction period of time in a surface treatment in a mixing process.

FIG. 9 is a graph that shows a change in reliability due to a reaction temperature in the mixing process.

FIG. 10 is a graph that shows a change in peak intensity and reliability due to a ratio of existence of Al/(Sr+Ba) element.

FIG. 11 is a graph that shows a change in conductivity of evaluation samples obtained in embodiment 6.

### DETAILED DESCRIPTION OF THE PREFERRED EMBODIMENTS

Referring to Figs., the following description will discuss embodiments of the present invention (hereinafter, referred to as “the present embodiment”) in detail in the following order:
1. Method of producing a coated phosphor
2. Application example of the coated phosphor
2-1. White light source
2-2. Illumination apparatus
3. Examples

### 1. METHOD OF PRODUCING A COATED PHOSPHOR

A method of producing a coated phosphor in accordance with the present embodiment includes a mixing process in which a phosphor and aluminum alkoxide are mixed in a solvent. Next, the method of producing a coated phosphor of the present embodiment includes a separation process for separating the mixed solution into a solid phase and a liquid phase.

### (Mixing Process)

In the mixing process, the phosphor and aluminum alkoxide are mixed in a solvent so that the phosphor is coated with an aluminum oxide formed from aluminum alkoxide. In this case, to coat the phosphor with the aluminum oxide formed from aluminum alkoxide is not limited to, for example, a state in which the aluminum oxide is uniformly adhered to the surface of the phosphor, and includes a state in which the aluminum oxide is unevenly adhered to the surface of the phosphor, and a state in which some portions on the surface of the phosphor include portions where no aluminum oxide is adhered. In the mixing process, by mixing the phosphor and aluminum alkoxide in a solvent, aluminum alkoxide is hydrolyzed in the mixed solution to start a sol-gel reaction so that a coated phosphor in which the phosphor is coated with the aluminum oxide formed from aluminum alkoxide is obtained. That is, by using a sol-gel method, a mixed solution in which the phosphor is coated with the aluminum oxide is prepared.

For example, in the mixing process, a first solution prepared by a phosphor and a solvent and a second solution prepared by aluminum alkoxide and a solvent are prepared. In a reaction device, by adding the second solution to the first solution or by adding the first solution to the second solution, the phosphor and the aluminum alkoxide are mixed in the solvent so that a mixed solution is obtained.

As the phosphor, an oxide phosphor (hereinafter, referred to simply as “phosphor”) containing Group II element (M), europium (Eu), silicon (Si) and oxygen (O) in atomic weight ratios represented by the following composition formula (1) is used. This phosphor is a silicate-based phosphor having a light emission peak in a wavelength from 600 to 610 nm, and has good characteristics (phosphor characteristics, etc.) as a phosphor.

[(M)₁₋ₓEuₓ]ₐSi_{b}O_{c} Composition Formula (1)

In the composition formula (1), M represents Group II element, and a, b, c and x satisfy relationships: 1.8<a<3.3; 0.9<b<1.1; 3.6<c<5.5; and 0<x<0.09.

In the case when, as the Group II element, for example, strontium (Sr) and barium (Ba) are contained, a phosphor containing strontium (Sr), barium (Ba), europium (Eu), silicon (Si) and oxygen (O) in atomic weight ratios represented by the following composition formula (2) may be used:

[(Ba_{1-y}Sr_{y})₁₋ₓEuₓ]ₐSi_{b}O_{c} Composition Formula (2)

In the composition formula (2), a, b, c, x and y satisfy relationships: 1.8<a<3.3; 0.9<b<1.1; 3.6<c<5.5; 0<x<0.09; and 0.25<y<0.75.

The aluminum alkoxide is used for forming an aluminum oxide for use in coating the phosphor by a hydrolysis (sol-gel method), that is, an alumina coat made of an aluminum oxide, an aluminum oxide hydrate (alumina hydrate), aluminum hydroxide or a mixture of these. Among metal alkoxides, by using aluminum alkoxide, since the aforementioned phosphor that is fragile to moisture is coated with the aluminum oxide having a superior moisture resistance, the moisture resistance of the phosphor is improved so that the light emitting characteristic of the phosphor can be maintained for a long period of time. Moreover, since the aluminum alkoxide has a rapid reaction speed, it is not necessary to use an excessive amount of H₂O, and it is possible to prevent the degradation of the phosphor from being accelerated.

As the aluminum alkoxide, for example, selection is made from those of ethoxide, methoxide, isopropoxide, butoxide, etc., and specific examples include: aluminum isopropoxide, aluminum tert-butoxide, aluminum triethoxide, aluminum tri-n-propoxide, aluminum isopropoxide, aluminum tri-n-butoxide, aluminum triisobutoxide, sec-butoxide aluminum diisopropoxide, aluminum tri-sec-butoxide, aluminum-tert-tributoxide, etc. Moreover, as the aluminum alkoxide, a coupling agent having an alkyl group, an amino group, a mercapto group or the like that do not devote to a sol-gel reaction, such as alkylalkoxide aluminum, may be used. Among these aluminum alkoxides, from the viewpoint of providing good moisture resistance to the phosphor, aluminum isopropoxide is preferably used.

In the mixing process, the atomic weight ratio of aluminum in the aluminum oxide relative to the Group II element (atomic weight of aluminum/atomic weight of Group II element) in the phosphor, that is, the ratio of existence of (Al/Group II element), is preferably set to 0.10 or more, more preferably, to 0.10 to 0.29. By setting the ratio (atomic weight of aluminum/atomic weight of Group II element) to 0.10 to 0.29, since virtually the entire surface of the phosphor coated with the aluminum oxide having good moisture resistance, the moisture resistance of the phosphor is further improved, making it possible to maintain the light emitting characteristic of the phosphor for a longer period of time.

Moreover, the ratio (atomic weight of aluminum/atomic weight of Group II element) is more preferably set to 0.10 to 0.20. By setting the ratio (atomic weight of aluminum/atomic weight of Group II element) to 0.10 to 0.20, the aggregation of the coated phosphor can be reduced. With this arrangement, for example, upon potting a resin composition containing the coated phosphor and a resin component to a resin filling unit of a case (package) in which LED light emitting elements are placed, it is possible to prevent the device for use in potting the resin composition from being lowered in its handling property.

As the solvent, not particularly limited as long as it is a solvent capable of dispersing uniformly, for example, water, an organic solvent, or the like, may be used. As the organic solvent, alcohol, ether, ketone, polyhydric alcohols or the like may be used. As the alcohols, for example, methanol, ethanol, propanol and pentanol may be used. As the polyhydric alcohols, for example, ethylene glycol, propylene glycol and diethylene glycol may be used. Moreover, as the solvent, a single solvent or a mixed solvent of two or more kinds thereof may be used.

The above-mentioned aluminum alkoxide generally has a fast reaction speed, and is easily hydrolyzed with a small amount of water. For this reason, in the case when aluminum alkoxide is used as the metal alkoxide, it is possible to perform a reaction for coating the phosphor with aluminum oxide formed by the aluminum alkoxide, without the necessity of using a catalyst.

Additionally, in the reaction process, a catalyst may be used. As the catalyst, a basic catalyst and an acidic catalyst may be commonly used; however, when degradation of the phosphor is taken into consideration, the basic catalyst is more preferably used.

As the reactor for use in mixing the phosphor and aluminum alkoxide in a solvent, for example, a glass or polyethylene (PE) container with a magnetic stirrer or stirring blades may be used. As the reactor, in order to suppress the sticking and maldistribution of particles during the process, such a vessel with a flat bottom having such a size as not to allow a stirring bar (stirring blades) to have a gap with the vessel bottom surface is preferably used.

In the mixing process, the temperature at which the phosphor and aluminum alkoxide are mixed in a solvent is preferably set to 30 to 50° C., more preferably, to 35 to 45° C. In this manner, by mixing the phosphor and aluminum alkoxide in a solvent at 30 to 50° C., the phosphor can be sufficiently coated with an aluminum oxide formed by a hydrolysis of aluminum alkoxide so that it is possible to effectively prevent the phosphor from degradation due to moisture. Thus, it becomes possible to maintain the light emitting characteristic of the phosphor for a longer period of time.

In the mixing process, the time during which the phosphor and aluminum alkoxide are mixed in a solvent is preferably set to 30 to 90 minutes, more preferably, to 45 to 75 minutes. In this manner, by mixing the phosphor and aluminum alkoxide in a solvent for 30 minutes or more, the phosphor can be sufficiently coated with an aluminum oxide formed by a hydrolysis of aluminum alkoxide so that it is possible to effectively prevent the phosphor from degradation due to moisture. Moreover, by setting the time during which the phosphor and aluminum alkoxide are mixed in a solvent to 90 minutes or less, the aluminum oxide with which the phosphor is coated is prevented from being peeled off, and it becomes possible to effectively prevent the phosphor from degradation due to moisture. Consequently, by setting the time during which the phosphor and aluminum alkoxide are mixed in a solvent to 30 to 90 minutes, it becomes possible to maintain the light emitting characteristic of the phosphor for a longer period of time.

### (Separation Process)

In a separation process, by separating the mixed solution obtained by mixing the phosphor and aluminum alkoxide in a solvent in the mixing process into a solid phase and a liquid phase, a coated phosphor serving as the solid phase can be obtained from the mixed solution.

For example, in the separation process, by using a suction filter, the mixed solution is separated into a solid phase and a liquid phase, and the separated solid phase is dried, and the dried sample thus obtained is pulverized, and subjected to a firing treatment. Thus, a coated phosphor in which the phosphor is coated with an aluminum oxide can be obtained.

Upon separating the mixed solution into the solid phase and the liquid phase, since aluminum alkoxide tends to be influenced by H₂O contained in the air, the inside of the testing system is preferably substituted with dried N₂ gas.

The temperature at which the separated solid phase is tried is preferably set to 80 to 110° C., although the drying temperature can be altered depending on a solvent to be used. Moreover, the drying time for drying the separated solid phase is preferably set to 2 hours or more.

As a method for pulverizing the dried sample thus obtained, for example, a pulverizing method by the use of an agate mortar is preferably used so as to alleviate particle aggregation.

The temperature at which the pulverized sample is fired is preferably set to 150 to 350° C., more preferably, to 150 to 250° C. Moreover, the firing time for the pulverized sample is preferably set to 8 hours or more.

The coated phosphor, obtained by the above-mentioned method of producing a coated phosphor in accordance with the present embodiment, has a structure in which the phosphor is coated with an aluminum oxide, and the phosphor contains a group II element (M), europium (Eu), silicon (Si) and oxygen (O) at atomic weight ratios represented by the aforementioned composition formula (1). This coated phosphor has superior phosphor characteristics, and since the phosphor is coated with an aluminum oxide having superior moisture resistance, the moisture resistance of the phosphor is improved so that the light emitting characteristic of the phosphor can be maintained for a long period of time.

Additionally, in the above explanation, a method in which, upon preparing a coated phosphor, a coating treatment of the aluminum oxide onto the phosphor is carried out only once, that is, a method in which only one layer of the aluminum oxide is formed on the phosphor, is exemplified; however, the present invention is not intended to be limited by this example. For example, by carrying out the coating treatment of the aluminum oxide repeatedly, the phosphor may be coated with two or more layers of the aluminum oxide. In the method of producing the coated phosphor in accordance with the present embodiment, when a multiple layers of the aluminum oxide are formed on the phosphor, a reduction in the peak intensity of the phosphor and aggregation of particles tend to occur; therefore, the number of coating treatments of the aluminum oxide is preferably set to 2 to 3 times.

### 2. APPLICATION EXAMPLE OF COATED PHOSPHOR

The coated phosphor obtained by the above-mentioned method of producing a coated phosphor is applicable to, for example, a white light source and an illumination apparatus.

### <2-1. White Light Source>

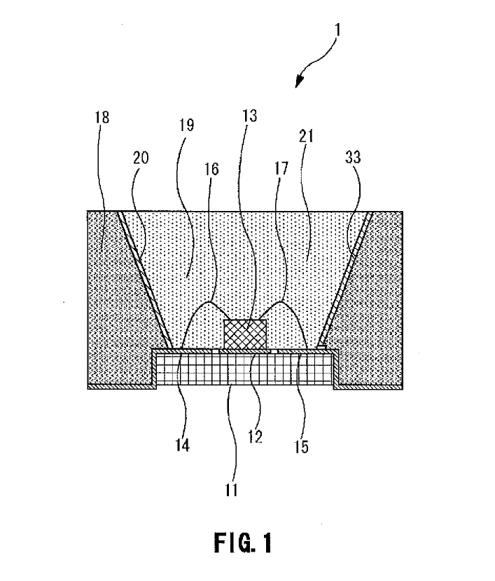

First, referring to a schematic cross-sectional view shown in FIG. 1, a white light source relating to the present embodiment will be explained. As shown in FIG. 1, a white light source 1 is provided with a blue light emitting diode 13 on a pad portion 12 formed on an element substrate 11. On the element substrate 11, electrodes 14 and 15 for use in supplying power so as to drive the blue light emitting diode 13 are formed with an insulating property, and the respective electrodes 14 and 15 are connected to the blue light emitting diode 13, for example, by lead lines 16 and 17.

Moreover, on the periphery of the blue light emitting diode 13, for example, a resin layer 18 is formed, and an opening 19 is formed on the resin layer 18 so that the blue light emitting diode 13 is exposed therethrough. This opening 19 is formed so as to have a slanting surface, with the opening area being widened in the light emitting direction of the blue light emitting diode 13, and a reflection film 20 is formed on the slanting surface. In other words, in the resin layer 18 having the funnel-shaped opening 19, the wall face of the opening 19 is covered with the reflection film 20, and the blue light emitting diode 13 is disposed on the bottom surface of the opening 19. Moreover, into the opening 19, a knead matter 21 prepared by kneading a red phosphor and a green phosphor into a transparent resin is embedded so as to cover the blue light emitting diode 13; thus, a white light source 1 is constructed.

As the red phosphor, the coated phosphor represented by the aforementioned composition formulas (1) and (2) is used. This red phosphor provides a peak light emission wavelength within a red wavelength band, and its light emitting intensity is strong, with high luminescence. For this reason, bright white light with a wide color range, derived from three primary colors of light rays composed of a blue light ray of the blue light LED, a green light ray from the green phosphor and a red light ray from the red phosphor, can be obtained.

### <2-2. Illumination Apparatus>

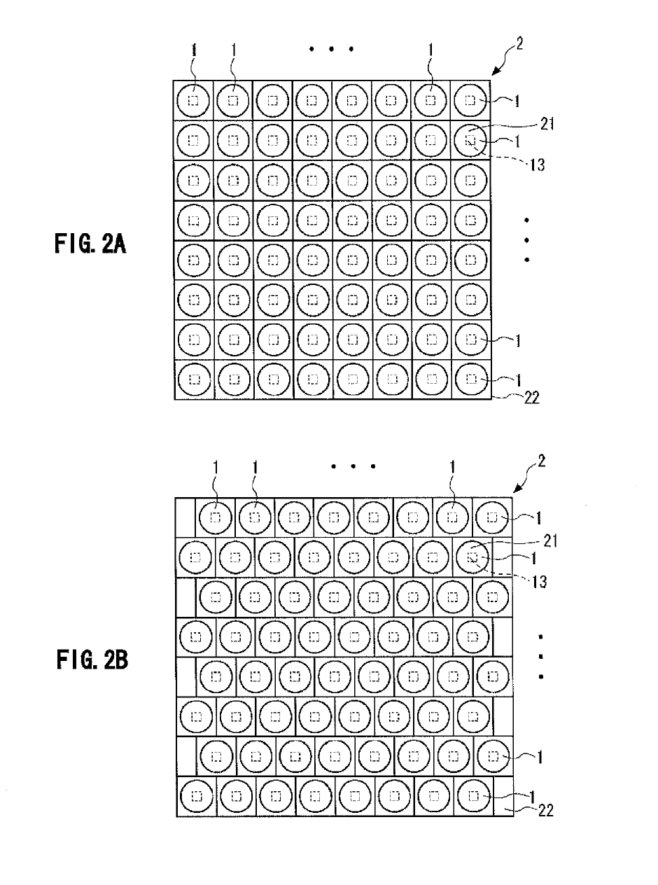

Next, referring to a schematic plan view of FIG. 2, an illumination apparatus of the present embodiment will be explained. As shown in FIG. 2, an illumination apparatus 2 has a structure in which a plurality of white light sources 1 explained by using FIG. 1 are disposed on an illumination substrate 22. In its layout example, as shown in FIG. 2(A), a square lattice layout may be used, or as shown in FIG. 2(B), a layout whose pitches are shifted by, for example, a ½ pitch, for every other line, may be used. In this case, the pitch to be shifted is not limited to a ½ pitch, and may be set to a ⅓ pitch, or a ¼ pitch. Moreover, the shift may be made for every other line, or for every plural lines (for example, two lines).

Although not shown in Figs., a layout whose pitches are shifted by, for example, a ½ pitch for every other row may be used. The pitch to be shifted is not limited to a ½ pitch, and may be set to a ⅓ pitch, or a ¼ pitch. Moreover, the shift may be made for every other line, or for every plural lines (for example, two lines). That is, the way how to shift the white light source 1 is not necessarily limited.

The white light source 1 has the same structure as that explained by reference to FIG. 1. That is, the white light source 1 has a structure in which the kneaded matter 21 prepared by kneading a red phosphor and a green phosphor in a transparent resin is placed on the blue light emitting diode 13. As the red phosphor, a red phosphor represented by the aforementioned composition formula (1) is used.

Moreover, since the illumination apparatus 2 has a structure in which a plurality of white light sources 1 each of which is virtually equivalent to point light emission are disposed on an illumination substrate 22 longitudinally as well as laterally, it provides light emission equivalent to surface light emission; therefore, for example, it can be used for a backlight of a liquid crystal display. Moreover, the illumination apparatus 2 may be used for illumination apparatuses for various applications, such as normal illumination apparatuses, illumination apparatuses for photography, illumination apparatuses for construction sites, etc.

Since the white light source 1 is used therein, the illumination apparatus 2 can provide white light that is bright and has a wide color range. For example, when it is used as a backlight for a liquid crystal device, a pure white color with high luminance is obtained on the display screen so that it is possible to improve the quality of the display screen.

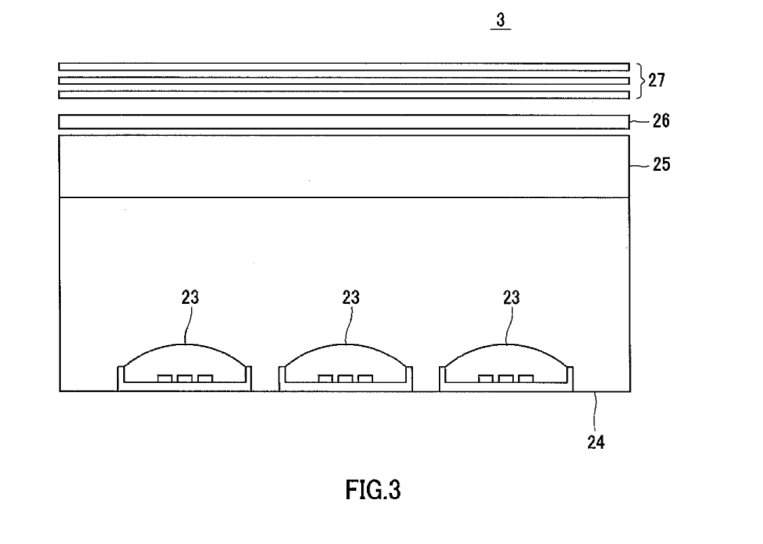

Moreover, the coated phosphor in accordance with the present embodiment may be applied to, for example, a phosphor sheet for use in an illumination apparatus. For example, as shown in FIG. 3, the illumination apparatus 3 is provided with light emitting structural bodies 23 each of which has blue light emitting elements that are contained in a transparent resin having a convex shape in its surface shape, a substrate 24 on which the light emitting structural bodies 23 are two-dimensionally disposed, a diffusion plate 25 that defuses blue light emitted from the blue light emitting elements, a phosphor sheet 26 that is disposed with a space from the substrate 24, and contains a phosphor in the state of powder so as to obtain white light from blue light of the blue light emitting elements, and an optical film 27.

The substrate 24 and the phosphor sheet 26 are disposed with a space of about 10 to 50 mm from each other, and the illumination apparatus 3 is constituted so as to have a so-called remote phosphor structure. The gap between the substrate 24 and the phosphor sheet 26 is supported by a plurality of supporting pillars and a reflection plate, and the supporting pillars and the reflection plate are formed so as to surround a space formed by the substrate 24 and the phosphor sheet 26 from its four sides.

Each of the light emitting structural bodies 23 forms a so-called LED package having, for example, InGaN-based blue LED (Light Emitting Diode) chips, as blue light emitting elements.

The substrate 24 forming the illumination apparatus is constituted by a glass cloth base member that utilizes a resin, such as phenol, epoxy, polyimide, polyester, bismaleimide-triazine, and allylated polyphenylene oxide resins. On the substrate 24, the light emitting structural bodies 23 are two-dimensionally disposed with equal intervals with a predetermined pitch over the entire surface of the phosphor sheet 26. Moreover, if necessary, a reflection treatment may be carried out on the mounting surface of the light emitting structural bodies 23 on the substrate 24.

The diffusion plate 25 is adapted to diffuse emitted light from the light emitting structural bodies 23 in a wide range in such a degree as to make the shape of the light sources invisible. As the diffusion plate 25, a plate having the total light transmittance of 20% or more to 80% or less is used.

The phosphor sheet 26 contains a phosphor in the form of powder so as to obtain white light from blue light of the blue light emitting elements. As the phosphor, for example, a sulfide phosphor, an oxide phosphor, or a mixed phosphor of these may be used. As the oxide-based phosphor, the above-mentioned coated phosphor is used. As the powder of the phosphor, that having an average particle size in a range from several μms to several tens of μms is preferably used. Thus, it becomes possible to improve the light scattering effect of the phosphor sheet 26.

The optical film 27 is composed of, for example, a reflection-type polarizing film for use in improving the visibility of a liquid crystal display, a lens film, a diffusion film, or the like. In this case, the lens film is an optical film in which microscopic lenses are arranged and formed on one of its surfaces, and is used so as to enhance the directivity in the front direction of diffused light and consequently to improve the luminance.

### EXAMPLES

The following description will discuss examples of the present invention. In the present examples, coated phosphors were produced in accordance with examples 1 to 6, as well as comparative examples 1 to 4, and with respect to the coated phosphors thus produced, evaluations on light emitting characteristics, particle size-specific surface area measurements, high temperature-high moisture environmental tests and element elusion tests were carried out. However, the present invention is not intended to be limited by these examples.

### Example 1

Predetermined amounts of a phosphor [(Ba, Sr)_{0.97}Eu_{0.03}]₃SiO₅ (5 g), ethanol (40 g) and pure water (H₂O) (0.375 g) were precisely weighed so that a first solution was prepared. Next, a second solution in which aluminum isopropoxide (0.75 g) and toluene were dissolved at predetermined ratios was prepared. The first solution that had been dispersed and mixed by an ultrasonic stirring process was adjusted to 40° C. in a thermostat, and to this was then added the second solution so that a reaction was started. The reaction container was taken out of the thermostat 60 minutes after the addition of the second solution, and after particles had been precipitated, a supernatant liquid was removed from the reaction container and filtered under reduced pressure. Thereafter, the sample was dried in an oven at 85° C. for 2 hours, and after having been ground in an agate mortar, the resulting sample was subjected to a firing process at 200° C. for 8 hours so that an evaluation sample (test sample) was obtained. In example 1, the atomic weight ratio (atomic weight of aluminum/(atomic weight of strontium+atomic weight of barium)) of aluminum in aluminum alkoxide relative to the total sum (Sr+Ba) of the two Group II elements, that is, Al/(Sr+Ba) element existence ratio, was adjusted to 0.1161.

### Example 2

In example 2, the same processes as those of example 1 were carried out except that the Al/(Sr+Ba) element existence ratio was adjusted to 0.1603 so that an evaluation sample was obtained.

### Example 3

In example 3, the same processes as those of example 1 were carried out except that the Al/(Sr+Ba) element existence ratio was adjusted to 0.2279 so that an evaluation sample was obtained.

### Example 4

In example 4, the same processes as those of example 1 were carried out except that the Al/(Sr+Ba) element existence ratio was adjusted to 0.2834 so that an evaluation sample was obtained.

### Example 5

In example 5, the same processes as those of example 1 were carried out except that the Al/(Sr+Ba) element existence ratio was adjusted to 0.3081 so that an evaluation sample was obtained.

### Example 6

In example 6, the same processes as those of example 1 were carried out except that in place of the phosphor [(Ba, Sr)_{0.97}Eu_{0.03}]₃SiO₅, [(Ba,Sr)_{0.94}Eu_{0.06}]₂SiO₄ was used and that the Al/(Sr+Ba) element existence ratio was adjusted to 0.1901 so that an evaluation sample was obtained.

### Comparative Example 1

In comparative example 1, the same processes as those of example 1 were carried out except that aluminum isopropoxide was not used so that an evaluation sample was obtained.

### Comparative Example 2

In comparative example 2, the same processes as those of example 1 were carried out except that in place of aluminum isopropoxide, TEOS (5 g) serving as a metal alkoxide of silicon dioxide (SiO₂) was used to prepare a second solution, and that ammonia water (7 g) was used as a catalyst, so that an evaluation sample was obtained.

### Comparative Example 3

In comparative example 3, the same processes as those of example 1 were carried out except that aluminum isopropoxide was not used so that an evaluation sample was obtained.

### Comparative Example 4

In comparative example 4, the same processes as those of example 1 were carried out except that the Al/(Sr+Ba) element existence ratio was adjusted to 0.0479 so that an evaluation sample was obtained.

Table 1 collectively shows the results relative to the evaluation samples obtained in examples 1 to 5 and comparative examples 1 to 4.

TABLE 1

| | Comparative | Comparative | Comparative | Comparative | | | | | |
|---|---|---|---|---|---|---|---|---|---|
| | Example 1 | Example 2 | Example 3 | Example 4 | Example 1 | Example 2 | Example 3 | Example 4 | Example 5 |
| Al/(Sr + | — | — | — | 0.0479 | 0.1161 | 0.1603 | 0.2279 | 0.2834 | 0.3081 |
| Ba) | | | | | | | | | |
| element | | | | | | | | | |
| existence | | | | | | | | | |
| ratio | | | | | | | | | |
| Peak | 1 | 1.027 | 1 | 1.062 | 1.045 | 1.037 | 1.047 | 1.050 | 0.996 |
| intensity | | | | | | | | | |
| (uncoated | | | | | | | | | |
| one is | | | | | | | | | |
| defined as | | | | | | | | | |
| 1) | | | | | | | | | |
| Luminance | 1 | 1.026 | 1 | 1.062 | 1.052 | 1.047 | 1.054 | 0.056 | 1.011 |
| (uncoated | | | | | | | | | |
| one is | | | | | | | | | |
| defined as | | | | | | | | | |
| 1) | | | | | | | | | |
| Sample | 87.57 | 88.52 | 86.86 | 86.75 | 85.63 | 85.04 | 85.31 | 86.24 | 81.81 |
| absorption | | | | | | | | | |
| rate (%) | | | | | | | | | |
| Internal | 74.25 | 75.26 | 73.79 | 78.25 | 78.31 | 78.26 | 78.64 | 77.96 | 78.36 |
| quantum | | | | | | | | | |
| efficiency | | | | | | | | | |
| (%) | | | | | | | | | |
| External | 65.02 | 66.62 | 64.09 | 67.87 | 67.05 | 66.55 | 67.09 | 67.24 | 64.11 |
| quantum | | | | | | | | | |
| efficiency | | | | | | | | | |
| (%) | | | | | | | | | |
| D10 | 5.537 | 7.148 | 4.556 | 5.37 | 4.851 | 4.26 | 4.156 | 6.371 | 4.294 |
| D50 | 8.81 | 11.23 | 7.405 | 7.837 | 7.662 | 7.49 | 8.148 | 9.755 | 7.719 |
| D90 | 13.14 | 15.04 | 11.28 | 10.84 | 10.84 | 10.76 | 11.73 | 16.23 | 11.95 |
| Specific | 13446 | 9150 | 15785 | 16064 | 16032 | 14081 | 9982 | 8538 | 10311 |
| surface | | | | | | | | | |
| area | | | | | | | | | |
| (cm²/cm³) | | | | | | | | | |

### <Light Emitting Characteristic Evaluation>

The light emitting characteristics of the evaluation samples obtained in examples 1 to 5 and comparative examples 1 to 4 were evaluated by using an FP6500 (made by JASCO Corporation). In Table 1, “sample absorption rate” refers to a ratio of a reduced portion of incident light derived from excited light caused by the sample. Moreover, “internal quantum efficiency” in Table 1 refers to a value obtained by dividing the number of photons of excited light absorbed by the sample by the number of photons of phosphor emitted from the sample. Furthermore, “external quantum efficiency” in Table 1 refers to a value obtained from an expression (sample absorption rate)×(internal quantum efficiency). The results of the light emitting characteristic evaluation are shown in Table 1.

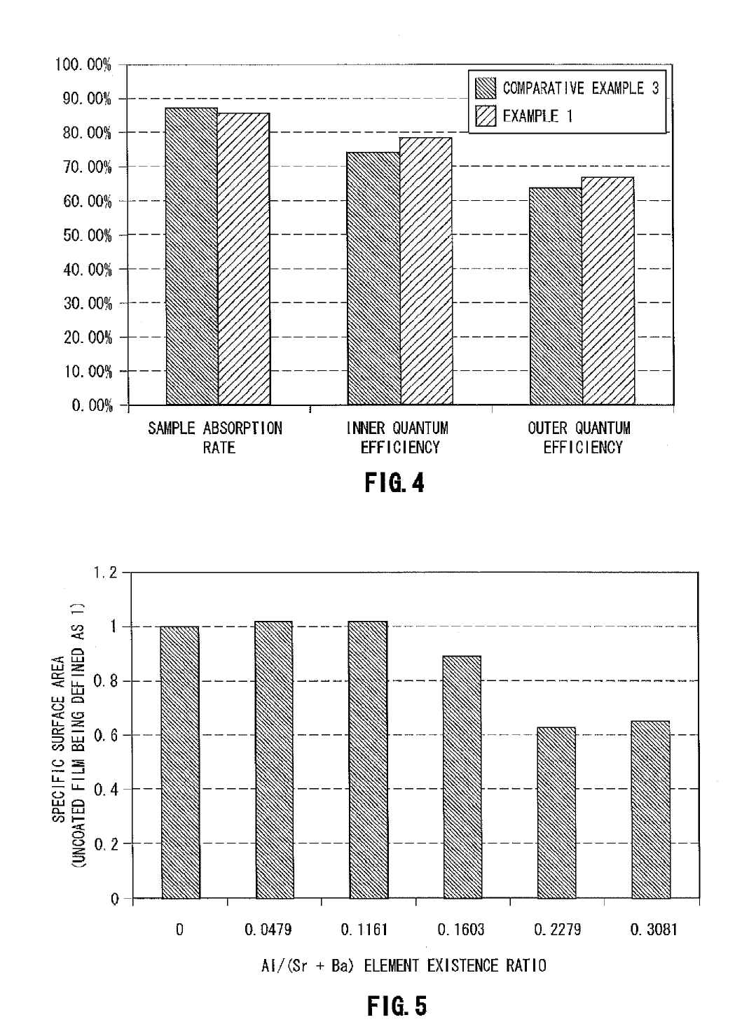

FIG. 4 shows light emitting characteristics before and after a coating treatment of the evaluation sample obtained in example 1. As shown in FIG. 4, although the sample absorption rate was slightly reduced after the coating treatment in comparison with that before the treatment, the internal quantum efficiency was improved so that it was confirmed that the external quantum efficiency was subsequently improved. It is considered that because of the lens effect by an aluminum oxide, light is more easily made incident on the inside of the coated phosphor from the outside and light is also more easily released from the inside of the coated phosphor toward the outside.

### <Particle Size-Specific Surface Area Measurements>

The particle size (D₁₀, D₅₀, D₉₀) of the evaluation samples obtained in examples 1 to 5 and comparative examples 1 to 4 were measured by using a Multisizer 4 (made by Beckman Coulter, Inc.). Moreover, the specific surface area was found by carrying out grain-size distribution measurements by using an LA-500 (made by Horiba, Ltd.). The results of the particle size-specific surface area measurements are shown in Table 1.

FIG. 5 shows the specific surface area of each of the evaluation samples obtained in examples 1 to 3, example 5, comparative example 3 and comparative example 4 relative to the Al/(Sr+Ba) element existence ratio. The Al/(Sr+Ba) element existence ratio was calculated by carrying out an ICP light emission spectrum analysis (ICP-AES) or a phosphor X-ray analysis (XRF) on each of the resulting evaluation samples. It is clarified that the specific surface area of the evaluation sample is lowered as the existence amount of the aluminum element increases. This is considered to imply that as the existence amount of the aluminum element increases, the aggregation of the evaluation sample takes place. It is confirmed that when the Al/(Sr+Ba) element existence ratio becomes 0.20 or more, the specific surface area of the evaluation sample is reduced to about 60% in comparison with the state in which the Al/(Sr+Ba) element existence ratio is 0.

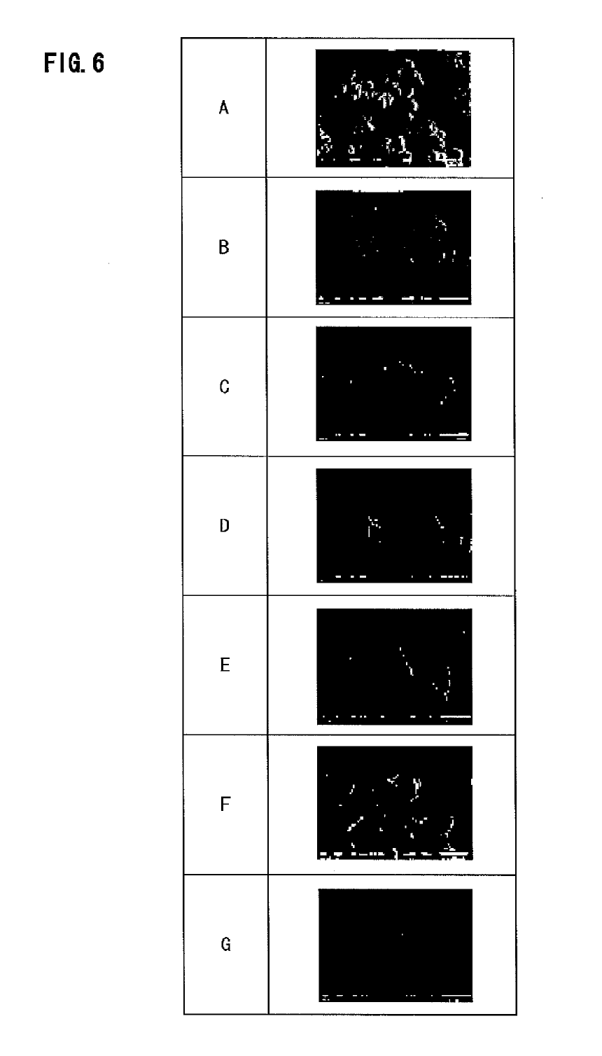

FIG. 6 shows electron microscopic photographs of evaluation samples obtained in comparative example 3, comparative example 4 and examples 1 to 5. A of FIG. 6 indicates the electron microscopic photograph of comparative example 3, B of FIG. 6 indicates that of comparative example 4, C of FIG. 6 indicates that of example 1, D of FIG. 6 indicates that of example 2, E of FIG. 6 indicates that of example 3, F of FIG. 6 indicates that of example 4, and G of FIG. 6 indicates that of example 5, respectively. Based upon the results of these, as described earlier, it is confirmed that as the existence amount of aluminum element increases, the aggregation of the evaluation sample occurs.

### <High-Temperature High-Humidity Environmental Change Tests>

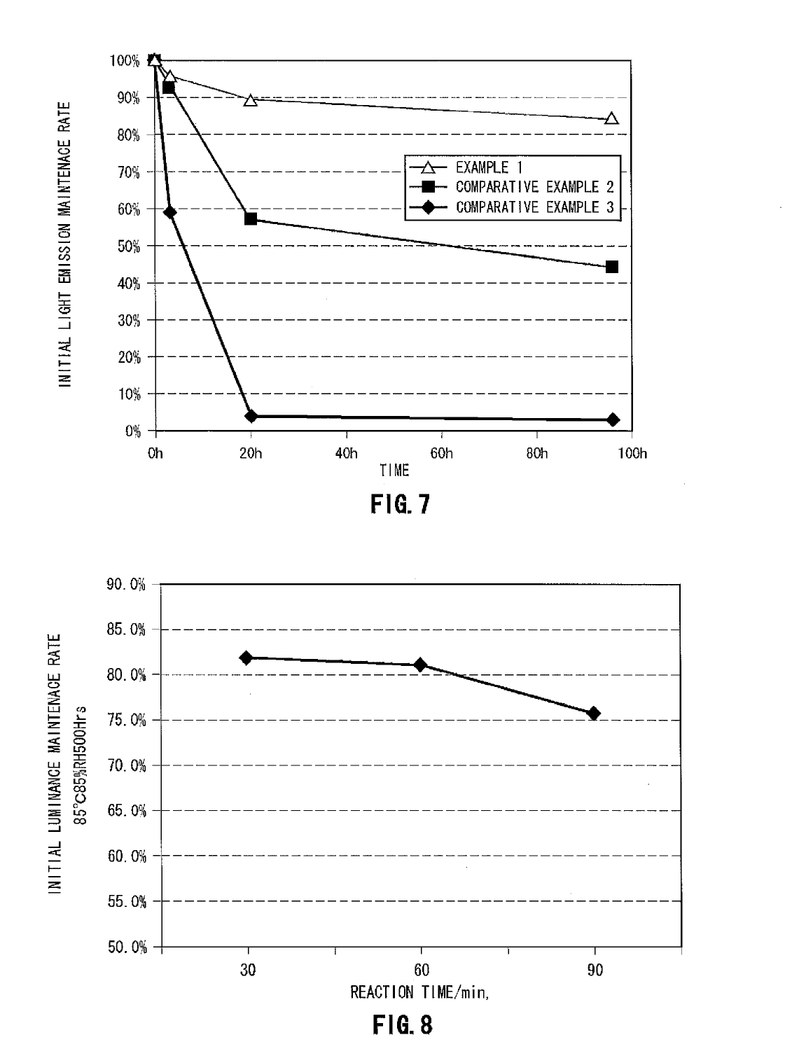

In high-temperature high-humidity environmental change tests, each of evaluation samples obtained in examples 1 to 5 and comparative examples 1 to 4 was subjected to a high-temperature high-humidity test at 60° C. and 90% RH or at 85° C. and 85% RH so that changes in the initial light emitting intensity or the like to those of 500 hours after the completion of the tests were confirmed. Upon measuring the light emitting intensity, a spectrophotometer FP-6500 (made by JASCO Corporation) was used. The results of the high-temperature high-humidity environmental change tests are shown in FIG. 7. In FIG. 7, symbol (Δ) indicates the result of the evaluation sample obtained in example 1. Moreover, symbol (▪) indicates the result of the evaluation sample obtained in comparative example 2. Furthermore, symbol (♦) indicates the result of the evaluation sample obtained in comparative example 3.

In the case of the evaluation sample (comparative example 3) having subjected to no coating treatment, degradation was caused abruptly in 3 hours under the testing environment. In the case of the evaluation sample (comparative example 2) having the phosphor coated with TEOS, great degradation in luminance was caused 24 hours later. In contrast, in the case of the evaluation sample prepared in example 1, it was confirmed that even nearly 100 hours after the test, light emission of about 90% of the initial light emission was maintained. As a result, it was confirmed that, although the evaluation sample (comparative example 2) having the phosphor coated with TEOS was abruptly whitened in 20 hours, the evaluation sample (example 1) having the phosphor coated with aluminum oxide was greatly improved in its moisture resistance. It is considered that since the phosphor is coated with aluminum oxide, the phosphor is improved in its moisture resistance, thereby making it possible to maintain the light emitting characteristic of the phosphor for a long period of time.

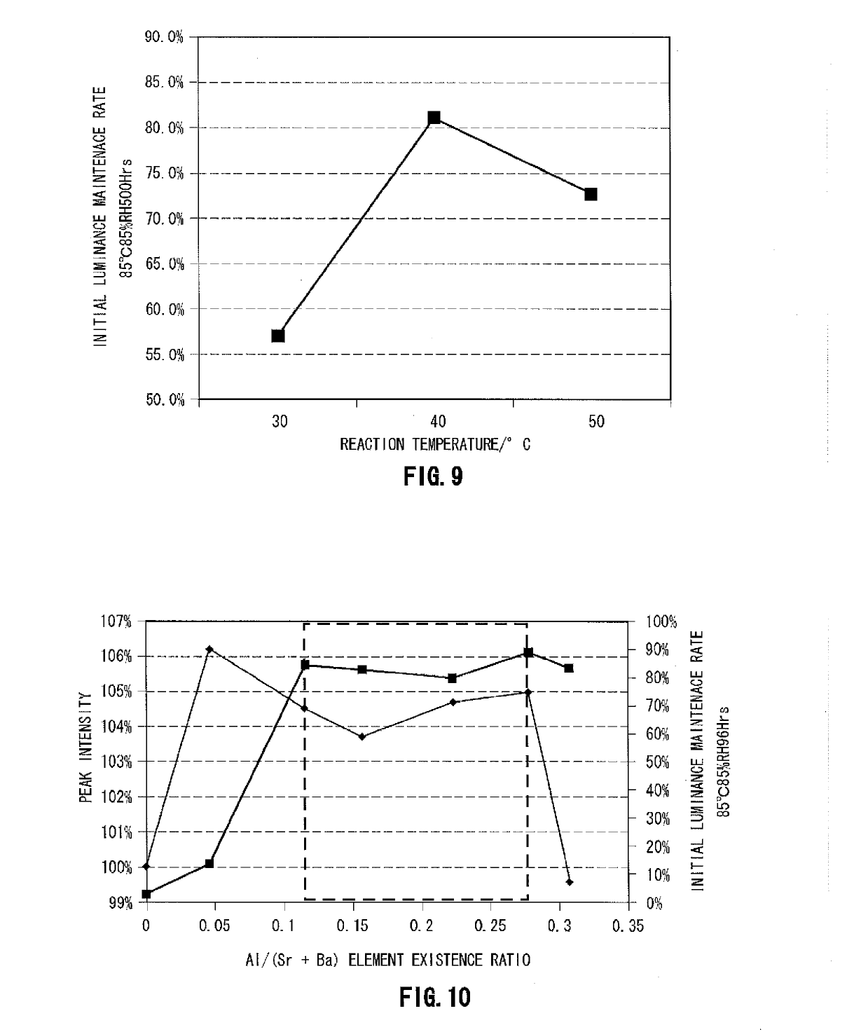

FIGS. 8 and 9 indicate changes in reliability due to the surface treatment reaction time and the reaction temperature environment. Based upon the results shown in FIGS. 8 and 9, it was confirmed that in the case when the phosphor and aluminum alkoxide were reacted in a solvent for 60 minutes, as well as in the case when the phosphor and aluminum alkoxide were mixed in a solvent at 40° C., high reliability was obtained respectively.

FIG. 10 indicates peak intensities (symbol (♦)) with respect to the evaluation samples obtained in examples 1 to 5, comparative example 3 and comparative example 4, and results (symbol (▪)) obtained by carrying out a high-temperature high-humidity test at 85° C. and 85% RH and by confirming changes in the initial light emitting intensity or the like and those of 96 hours after the completion of the tests. As indicated in FIG. 9, it is confirmed that in the evaluation samples obtained in examples 1 to 4, that is, in the case of the evaluation samples in which Al/(Sr+Ba) element existence ratio (atomic weight of aluminum/(atomic weight of strontium+atomic weight of barium)) is set to 0.10 to 0.29, superior phosphor characteristics are obtained and it is possible to maintain good light emitting characteristic for a long period of time.

Moreover, from the results of the specific surface area shown in FIG. 5, it is confirmed that in the case of the evaluation samples (example 1 and example 2) in which the Al/(Sr+Ba) element existence ratio is set to 0.10 to 0.20, aggregation hardly occurs. Therefore, in the range of 0.10 to 0.20 in the Al/(Sr+Ba) element existence ratio, it is clarified that a coated phosphor that has superior phosphor characteristics, is less susceptible to aggregation, and can maintain a light emitting characteristic for a long period of time can be obtained.

### <Element Elution Test>

In order to confirm the reliability of the evaluation sample obtained in example 6, an element elution test was carried out. In the element elution test, to 100 ml of ion exchanged water heated to 55° C. was added 1 g of the evaluation sample obtained in example 6 or 1 g of the evaluation sample having no coating treatment, and changes in the electric conductivity at this time were recorded respectively in 0, 5, 10, 30 and 60 min intervals.

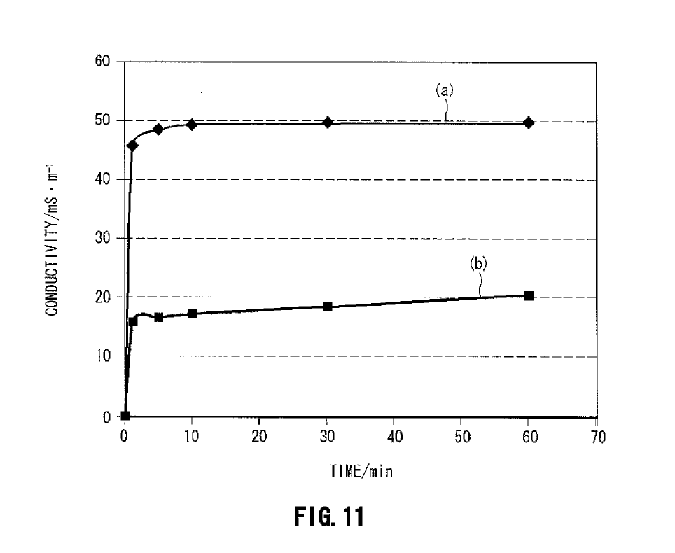

In FIG. 11, (a) represents the results of changes in electric conductivity of a phosphor with no aluminum oxide coated thereon, and (b) represents the results thereof of a phosphor coated with aluminum oxide. The results shown in FIG. 11 indicate that the phosphor coated with aluminum oxide makes it possible to reduce a rise in electric conductivity in a small level in comparison with the phosphor without being coated with aluminum oxide. This implies the fact that although a silicate phosphor elutes a Group II element to cause a change in electric conductivity when added to water, the element elution on the phosphor surface is suppressed by coating the phosphor with aluminum oxide. Therefore, it is considered that, with respect to phosphors other than the phosphor ([(Ba, Sr)_{0.97}Eu_{0.03}]₃SiO₅) used in examples 1 to 5 also, by coating them with aluminum oxide, it is possible to maintain their light emitting characteristic for a long period of time.

What is claimed is:

1. A method of producing a coated phosphor comprising the step of:
mixing a phosphor and aluminum alkoxide in a solvent so that the phosphor is coated with an aluminum oxide formed from the aluminum alkoxide,
wherein the phosphor contains Group II element (M), europium (Eu), silicon (Si) and oxygen (O) in atomic weight ratios represented by the following composition formula (1):
[(M)₁₋ₓEuₓ]ₐSi_{b}O_{c} Composition Formula (1)
In the composition formula (1), a, b, c and x satisfy relationships: 1.8<a<3.3; 0.9<b<1.1; 3.6<c<5.5; and 0<x<0.09.

2. The method of producing a coated phosphor according to claim 1, wherein the phosphor and the aluminum alkoxide are mixed in a solvent so as to allow aluminum in the aluminum oxide to have an atomic weight ratio relative to the Group II element (atomic weight of aluminum/ atomic weight of Group II element) in the phosphor in a range from 0.10 to 0.29.

3. The method of producing a coated phosphor according to claim 2, wherein in the mixing step, the phosphor and the aluminum alkoxide are mixed in the solvent at a temperature in a range from to 30 to 50° C.

4. The method of producing a coated phosphor according to claim 2, wherein in the mixing step, the phosphor and the aluminum alkoxide are reacted with each other in the solvent for 30 to 90 minutes.

5. The method of producing a coated phosphor according to any one of claims 2 to 4, wherein in the case when the phosphor contains strontium (Sr) and barium (Ba) as the Group II element (M), the phosphor contains strontium (Sr), barium (Ba), europium (Eu), silicon (Si) and oxygen (O) in atomic weight ratios represented by the following composition formula (2):
[(Ba_{1-y}Sr_{y})₁₋ₓEuₓ]ₐSi_{b}O_{c} Composition Formula (2)
In the composition formula (2), a, b, c, x and y satisfy relationships: 1.8<a<3.3; 0.9<b<1.1; 3.6<c<5.5; 0<x<0.09; and 0.25<y<0.75.

6. A coated phosphor comprising:
a phosphor coated with an aluminum oxide,
wherein the phosphor contains Group II element (M), europium (Eu), silicon (Si) and oxygen (O) in atomic weight ratios represented by the following composition formula (1):
[(M)₁₋ₓEuₓ]ₐSi_{b}O_{c} Composition Formula (1)
In the composition formula (1), a, b, c and x satisfy relationships: 1.8<a<3.3; 0.9<b<1.1; 3.6<c<5.5; and 0<x<0.09.

7. The coated phosphor according to claim 6, wherein aluminum in the aluminum oxide has an atomic weight ratio relative to the Group II element (atomic weight of aluminum/atomic weight of Group II element) in the phosphor in a range from 0.10 to 0.29.

8. A white light source comprising:
a blue light emitting diode formed on an element substrate;
a knead matter that is placed on the blue light emitting diode, and formed by kneading a red phosphor and a green phosphor or a yellow phosphor with a transparent resin,
wherein the red phosphor is a phosphor coated with an aluminum oxide, and the phosphor contains Group II element (M), europium (Eu), silicon (Si) and oxygen (O) in atomic weight ratios represented by the following composition formula (1):
[(M)₁₋ₓEuₓ]ₐSi_{b}O_{c} Composition Formula (1)
In the composition formula (1), a, b, c and x satisfy relationships: 1.8<a<3.3; 0.9<b<1.1; 3.6<c<5.5; and 0<x<0.09.
